(19) United States
(12) Patent Application Publication
(10) Pub. No.: US 2005/0209929 A1
(43) Pub. Date: Sep. 22, 2005

(54) System and method for client-side competitive analysis

(75) Inventors: Nathanael F. Ehrich, Raleigh, NC (US); Robert C. Leah, Raleigh, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/806,021

(22) Filed: Mar. 22, 2004

(51) Int. Cl. G06F 17/60

(52) U.S. Cl. 705/26

(57) ABSTRACT

A system and method for client-side competitive analysis is presented. When a provider server receives a portal's contribution request, the provider server includes an embedded program along with provider data in a contribution response, and sends the contribution response to the portal. In turn, the portal includes the provider data and the embedded program in a page of data, along with competitive data from other competitors, and sends the page of data to a client. While at the client, the embedded program extracts and processes the competitive data from the page of data. The embedded program may choose to alter the provider data based upon processing the competitive data, or the embedded program may choose to send the competitive data to the provider server for further analysis. In turn, the provider server may send a response to the embedded program to change the provider server's data that is located on the client's page of data.

### BACKGROUND OF THE INVENTION

1. Technical Field

The present invention relates in general to a system and method for client-side competitive analysis. More particularly, the present invention relates to a system and method for, at a client, non-invasively extracting and processing competitive information that is located in a page of data.

2. Description of the Related Art

The Internet has changed the consumer marketplace by providing a means for a user to efficiently shop, literally around the world. On a national scale, a user living in the Midwest is able compare product prices from a small, West Coast company with those from a small, East Coast company. The user may then buy the product from the lowest priced company. On a global scale, the same user is able to compare prices from companies outside the United States, such as those located in Europe or Japan.

When a company sells its products on a local scale, the company is able to analyze its competitors' advertising techniques, such as product pricing and visual content. For example, a company may purchase a local Sunday paper and analyze its competitor's color advertisement that includes sale items. When competing on the Internet, however, a company does not have the luxury of closely monitoring competitive information since the company may have hundreds of competitors that change prices on a daily basis.

In an effort to attract online customers, a company is able to control the way in which the company “presents” its products to an online customer when the online customer specifically accesses the company's web site. For example, a company may use a particular font size and background color to visually attract the online customer. However, online customers typically employ portals to perform the task of vendor and price comparison when shopping for merchandise. For example, an online customer may use “dealtime.com” to shop for an electronic device. In this example, dealtime.com searches the Internet for vendors that sell the electronic device, and dealtime.com includes the vendor data (i.e. company name and price) in a web page for the online customer to view.

A challenge found when a company's data is displayed through a portal is that the company does not have the ability to analyze its competitive environment. A portal requests a contribution from a company, and the portal decides where to place the company's contribution response on the portal's page of data. For example, the portal may have agreements with particular companies to highlight their products, such as placing them first on a web page or enlarging their font. As another example, a company's data may be placed on the bottom of the portal's page of data, which may not be viewable unless a user scrolls down to the bottom of the page.

What is needed, therefore, is a system and method for providing a company with the ability to non-invasively collect and process competitive information that is included in a page of data that is generated from a portal.

### SUMMARY

It has been discovered that the aforementioned challenges are resolved by using an embedded program to non-intrusively collect and process competitive data from a page of data that is located on a client computer system. When a portal receives a client request, the portal sends a contribution request to a provider server. The provider server includes an embedded program in its response that, in turn, is sent to the portal. The portal includes the embedded program in a page of data, and sends the page of data to the client. Once at the client, the embedded program extracts and processes competitive data that is also included in the page of data.

A client sends a request to a portal inquiring about a particular item. The portal is responsible for gathering information from businesses that correspond to client requests and including the information in a page of data to send to the client. The portal receives the request, and identifies businesses that correspond to the request. For example, the request may be an inquiry as to the price of a digital camera. In this example, the portal identifies online retailers that sell the particular digital camera.

The portal gathers product information by sending a contribution request to each identified online retailer's server. When a provider server receives the contribution request, the provider server retrieves provider data (i.e. price and availability) and also retrieves an embedded program. The provider server includes its provider data and the embedded program in a response, and sends the response to the portal.

In addition, other competitors' servers receive the portal's contribution request, and the competitors' servers send their respective competitive data to the portal for inclusion into the portal's page of data. For example, competitor data may include pricing, availability, and shipping information for a particular product.

Once the portal receives responses from each of the identified online retailers, the portal includes each of the responses in a page of data, and sends the page of data to the client. Since the portal includes the provider server's entire contribution, the embedded program is automatically included in the page of data.

The client receives the page of data, and displays the page of data on the client's display. For example, the page of data may include pricing and product availability from businesses for a particular product, as well as advertisements. In addition, the client loads the embedded program. For example, if the program is in the form of a JavaScript that is embedded in an HTML page, a web browser “interprets” the JavaScript, thus loading the program into memory. Once loaded at a client, the embedded program is designed to extract competitive data from the page of data, such as a Document Object Model (DOM). A DOM is an HTML page or an XML document that is represented as a full-fledged program object.

After the embedded program extracts and processes the competitive data, the embedded program may choose to automatically change the provider's data included in the page of data based upon analyzing the competitive data. For example, a competitor may advertise free product shipping and the provider currently charges ten dollars for shipping a product. In this example, the embedded program may negate the provider's shipping charges in order to win the client's business.

In one embodiment, the embedded program may be configured to extract competitive data from the page of data and provide the competitive data to the provider server for further analysis. In this embodiment, the embedded program sends the competitive data to the provider server through a computer network, such as the Internet. The provider server may choose to analyze the competitive data at a later time, or the provider server may choose to change its provider data in order to win business. For example, the competitive data may identify that one of the competitor's has a lower price than the provider server's price. In this example, the provider server may choose to lower its price in order to win the client's business. When the provider server wishes to have the embedded program modify the provider server's data included in the page of data at the client, the provider server sends changed data to the embedded program that, in turn, updates the page of data using the changed provider data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a client receiving a page of data that includes an embedded program that is adapted to identify competitive data within the page of data;

FIG. 2 is a client's display showing a page of data;

FIG. 3 is a high level flow chart showing steps taken in a client requesting a page of data and a portal processing the request by querying a provider which, in turn, embeds a program in the provider's response;

FIG. 4 is a flowchart showing steps taken in an embedded program analyzing competitive data included in a page of data;

FIG. 5 is a flowchart showing steps taken in a provider analyzing competitive data that it received from an embedded program that is located at a client; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

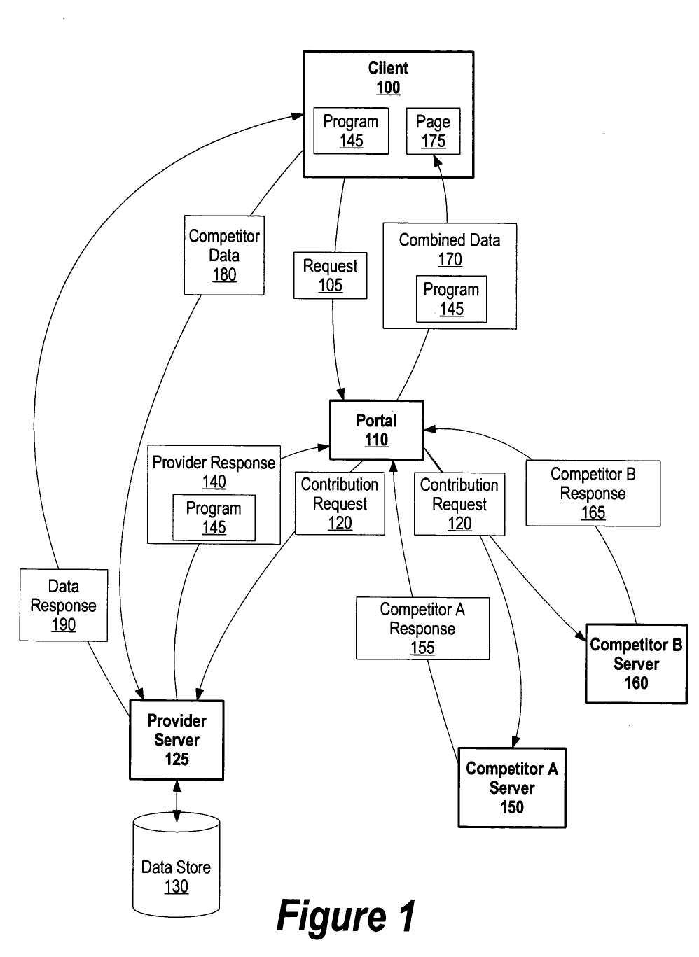

FIG. 1 is a diagram showing a client receiving a page of data that includes an embedded program that is adapted to identify competitive data within the page of data. Provider server 125 corresponds to a particular business, such as an online electronic retail store. Provider server 125 receives inquiries from users and portals (i.e. dealtime.com) requesting pricing and availability information for products that the business supports.

Client 100 sends request 105 to portal 110 inquiring about a particular item. Portal 110 is responsible for gathering information from businesses that correspond to request 105, and including the information in a page of data to send to client 100. Portal 110 receives request 105, and identifies companies that correspond to the request. For example, request 105 may be an inquiry as to the price of a digital camera. In this example, portal 110 identifies online retailers that sell the particular digital camera. FIG. 1 shows that portal 110 identifies three online retailers that sell the item corresponding to request 125, which are provider server 125, competitor A server 150, and competitor B server 160.

Portal 110 gathers product information by sending a contribution request, such as contribution request 120, to provider server 125, competitor A server 150, and competitor B server 160. Provider server 125 receives contribution request 120, and retrieves provider data (i.e. price and availability) and an embedded program from data store 130. Once loaded at a client, the embedded program is designed to extract competitive data from a page of data, such as a Document Object Model (DOM). A DOM is an HTML page or an XML document that is represented as a full-fledged program object. Provider server 125 includes its provider data and program 145 in a response, and sends provider response 140 to portal 110.

In addition, competitor A sever 150 and competitor B server 160 receive contribution request 120, and send competitor A response 155 and competitor B response 165, respectively, to portal 110 which includes competitive information. For example, the competitor responses may include pricing, availability, and shipping information for the particular product.

Once portal 110 receives responses from each of the servers, portal 110 includes each of the responses in a page of data, and sends combined data 170 to client 100. Since portal 110 included provider server 125's contribution, program 145 is automatically included in combined data 145.

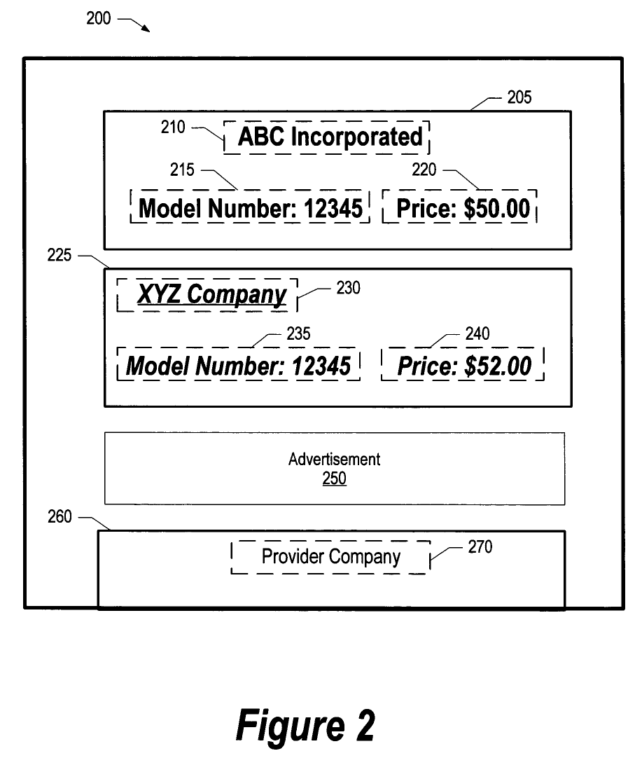

Client 100 receives combined data 170, and displays page 175 on client 100's display. For example, page 175 may include the three competitor's data (i.e. pricing, availability, etc.) as well as advertisements (see FIG. 2 and corresponding text for further details regarding page properties). In addition, client 100 loads program 145 whereby program 145 extracts competitive data from page 175.

Program 145 collects the competitive data, and may choose to automatically change the provider data in page 175 based on the competitive data. For example, a competitor may advertise free product shipping and the provider currently charges ten dollars for shipping a product. In this example, program 145 may negate the provider's shipping charges in order to win client 100's business.

In one embodiment, program 145 may be configured to extract competitive data from page 175 and provide the competitive data to provider server 125 for further analysis. In this embodiment, program 145 sends competitor data 180 to provider server 125 through a computer network, such as the Internet. Provider server 125 may choose to analyze the competitive data at a later time, or provider server 125 may choose to change its provider data in order to win business. For example, the competitive data may identify that one of the competitor's has a lower price than provider server 125. In this example, provider server 125 may choose to lower its price in order to win client 100's business. If provider server 125 wishes to update its data, provider server sends data response 190 to program 145 that includes changed provider data. Program 145 receives data response 190, and updates page 175 using the changed provider data.

FIG. 2 is a client's display showing a page of data. Window 200 displays a page of data that a client receives over a computer network, such as through the Internet from a portal. For example, the client's user may send a request to “dealtime.com” requesting the price of a particular electronic item. In this example, dealtime.com sends the client the page of data that includes product information that it received from an online retailer that corresponds to the electronic item, such as the price of a product.

Area 205 includes competitive data corresponding to a first online retailer that is displayed at the top of the page of data. Area 205 includes domain 210 (i.e. company name), and competitive data 215 and 220. Competitive data 215 includes a model number that corresponds to the client's request and competitive data 220 includes a price that corresponds to the client's request. In addition, area 205 displays the competitor's data in a large, bold, font, making it more appealing to a user. As one skilled in the art can appreciate, other types of competitive data may be displayed, such as shipping costs and product availability.

Area 225 includes competitive data corresponding to a second online retailer and is displayed in the middle of the page of data. Area 225 includes domain 230 (i.e. company name), and competitive data 235 and 240. Competitive data 235 includes a model number that corresponds to the client's request and competitive data 240 includes a price that corresponds to the client's request. In addition, area 225 displays the competitor's data in a large, bold, italicized font, making it more appealing to a user.

Advertisement 250 is an area which the page of data displays an advertisement. For example, the portal may display an advertisement from one of its sponsors, such as “doubleclick.com.”

Area 260 includes provider data that is not completely displayed due to its position on the page of data. A portion of the provider data shows domain 270, but does not include other information, such as a model number and a price that corresponds to the electronic device. When a user views window 200, the user may not notice area 260 because it starts at the bottom of the window, and advertisement 250 is between the other online retailers' information. In addition, the provider data is displayed with small, regular font that is not as noticeable as the competitive fonts. In this example, an embedded program identifies that the provider data is not optimally positioned relative to the competitive data.

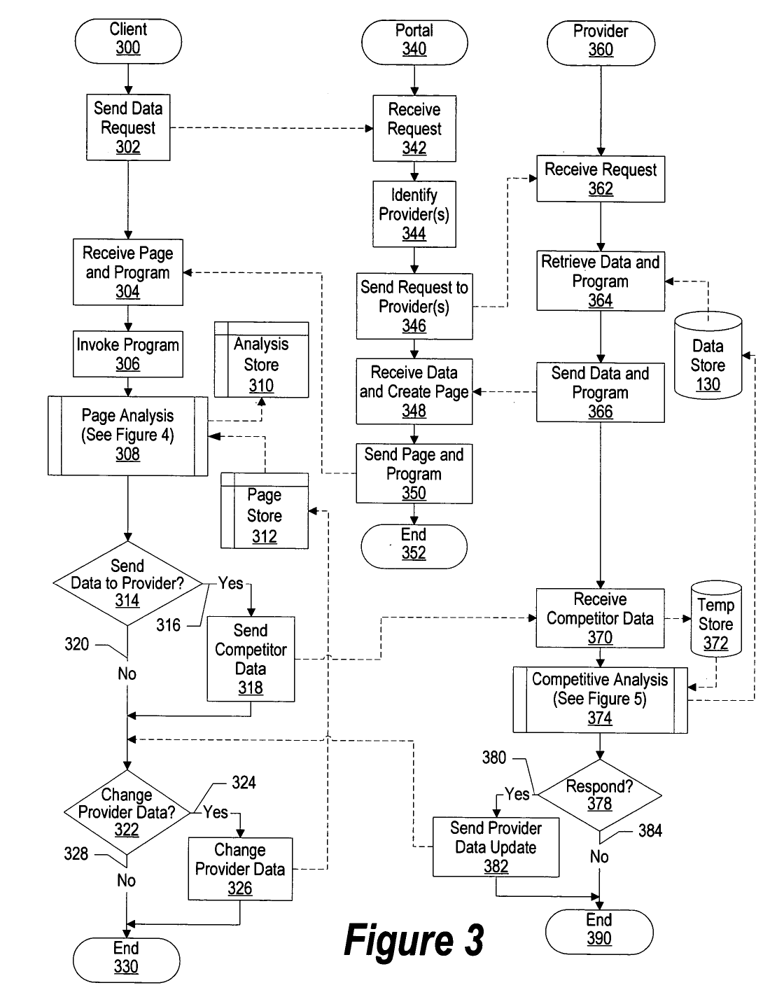

FIG. 3 is a high level flow chart showing steps taken in a client requesting a page of data and a portal processing the request by querying a provider which, in turn, embeds a program in the provider's response. Client processing commences at 300, whereupon the client sends a request to the portal at step 302. For example, the client's user may send a request to “dealtime.com” requesting the price of a particular electronic item, such as a digital camera.

Portal processing commences at 340, whereupon the portal receives the client's request at step 342. The portal identifies providers that correspond to the request, such as online electronic distributors, at step 344. At step 346, the portal sends a contribution request to the identified providers. Using the example described above, dealtime.com may identify four electronic distributors that sell the digital camera, and dealtime.com sends a contribution request to each of the four distributors.

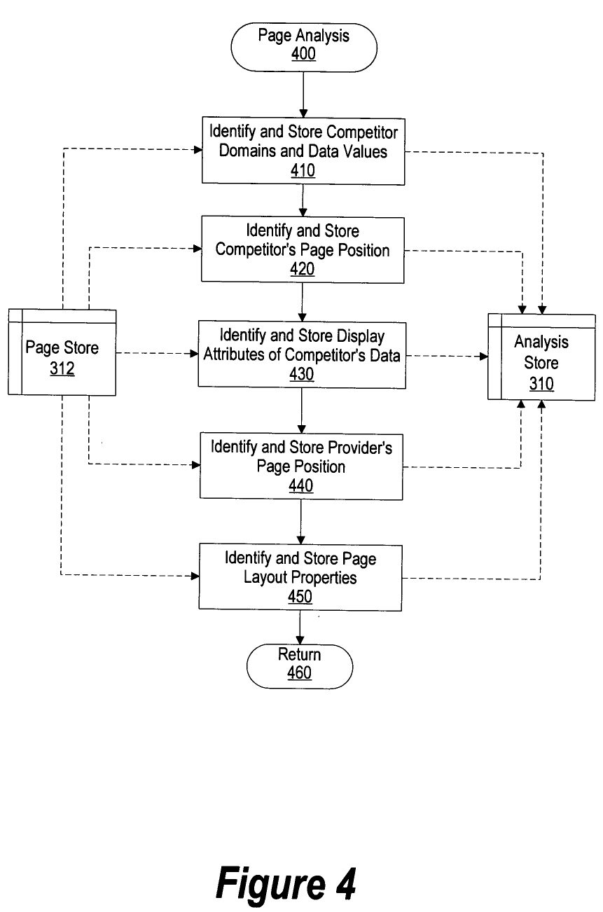

Provider processing commences at 360, whereupon the provider receives the contribution request from the portal at step 362. The provider retrieves provider data and an embedded program from data store 130 at step 364. Provider data may include items such as the price of a particular electronic device, display attributes (i.e. font size) corresponding to the provider's name, and other items such as logos and backgrounds. The embedded program is adapted to extract competitive data from a page of data that the portal generates and sends to the client (see FIG. 4 and corresponding text for further details regarding embedded program functionality). Data store 130 is the same as that shown in FIG. 1 and may be stored on a nonvolatile storage area, such as a computer hard drive. The provider includes the provider data and the embedded program in a contribution response, and sends the response to the portal at step 366.

The portal receives the provider's contribution response and includes it, as well as competitive data, in a page of data (step 348). The portal sends the page of data, which includes the embedded program, to the client at step 350, and portal processing ends at 352.

The client receives the page of data from the portal at step 304 which may be in the form of a Document Object Model (DOM). A DOM is an HTML page or an XML document that is represented as a full-fledged program object. Processing invokes the embedded program at step 306, and the embedded program extracts competitive data from page store 312 (the storage location of the page of data), and stores the competitive data in analysis store 310 (pre-defined process block 308, see FIG. 4 and corresponding text for further details). Analysis store 310 and page store 312 may be stored on a volatile storage area, such as internal memory.

A determination is made as to whether the embedded program wishes to send the competitive data to the provider (decision 314). For example, the embedded program may be configured to either automatically change provider data based upon its analysis of competitive data, or send the competitive data to the provider for the provider to make the determination. If the embedded program does not wish to send the competitive data to the provider, decision 314 branches to “No” branch 320 bypassing competitive data transmittal steps. On the other hand, if the embedded program wishes to send the competitive data to the provider, decision 314 branches to “Yes” branch 316 whereupon the embedded program sends the competitive data to the provider at step 318.

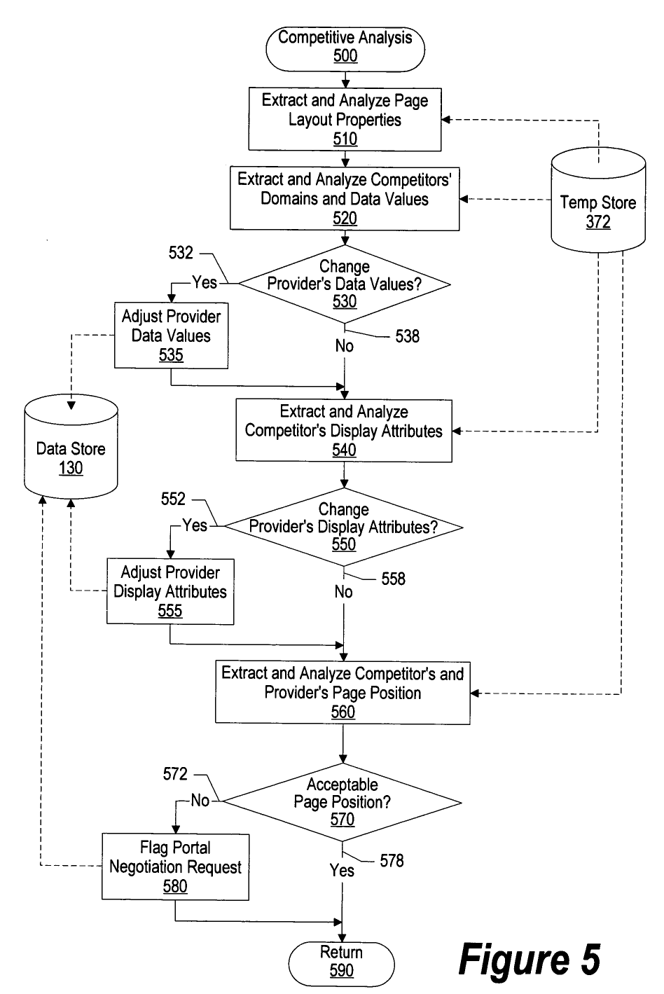

The provider receives the competitive data at step 370, and stores the competitive data in temp store 372. Temp store 372 may be stored on a nonvolatile storage area, such as a computer hard drive. The provider analyzes the competitive data to determine whether it should change its provider data (pre-defined process block 374, see FIG. 5 and corresponding text for further details). A determination is made as to whether the provider should send changed provider data to the embedded program to incorporate in the page of data (decision 378). If the provider does not wish to send changed provider data, decision 378 branches to “No” branch 384 bypassing changed provider data sending steps. On the other hand, if the provider wishes to send changed provider data, decision 378 branches to “Yes” branch 380 whereupon the provider sends the changed provider data at step 382, and provider processing ends at 390.

At the client, a determination is made as to whether to change the provider data that is included in page store 312 (decision 322). This determination may be based on the embedded program receiving data from the provider, or the determination may be based upon the embedded program's analysis of the competitive data and the embedded program making the determination on its own. If the embedded program should change the provider data, decision 322 branches to “Yes” branch 324 whereupon the embedded program changes the provider data included in page store 312 at step 326. On the other hand, if the embedded program should not change the provider data, decision 322 branches to “No” branch 328 bypassing provider data changing steps. Client processing ends at 330.

FIG. 4 is a flowchart showing steps taken in an embedded program analyzing competitive data included in a page of data. The embedded program corresponds to a provider that included the embedded program in a contribution request and the embedded program is adapted to extract competitive data from a page of data at a client. Processing commences at 400, whereupon the embedded program identifies competitor domains and data values that are located in page store 312, and stores the competitor domains and data values in analysis store 310 (step 410). For example, the embedded program may detect a competitor domain “ABC Incorporated” which sells an electronic device. In this example, the embedded program also identifies ABC Incorporated's data value, or price for the electronic device, which is “$50.00.” Page store 312 stores the page of data and is the same as that shown in FIG. 3. Analysis store 310 stores the extracted competitive data and is the same as that shown in FIG. 3.

At step 420, the embedded program identifies the competitor's page position from page store 312, and stores the page position in analysis store 310. For example, the embedded program may detect that three competitors have their data displayed at the top of the page of data. The embedded program then identifies display attributes corresponding to the competitors and stores the display attributes in analysis store 310 (step 430). For example, a competitor may use a large, bold font to display his data on the page of data.

At step 440, the embedded program identifies the provider's page position that is located in page store 312. For example, the provider's data may be displayed at the bottom of the page of data and a user is required to scroll to the bottom of the page of data in order to view the provider's data. The embedded program then identifies page and layout properties of the page of data at step 450, and stores them in analysis store 310. For example, the page of data may have particular space for advertisements and banners. Processing returns at 460.

FIG. 5 is a flowchart showing steps taken in a provider analyzing competitive data that it received from an embedded program that is located at a client. The provider included the embedded program in a contribution request, which was sent to a portal. In turn, the portal included the embedded program in a page of data that it sent to the client. Once at the client, the embedded program extracted competitive data included in the page of data, and sent the competitive data to the provider (see FIG. 4 and corresponding text for further details regarding competitive data extraction).

Processing commences at 500, whereupon processing extracts page layout properties from temp store 372 at step 510. For example, the page layout properties may include areas on the page of data that are dedicated to banner advertisements. Temp store 372 includes the competitive data and is the same as that shown in FIG. 3. Processing then extracts and analyzes competitor domains and data values from temp store 372 at step 520. For example, the page of data may have included three competitors, each having a different data value, or price, for a particular electronic device. In this example, processing may compare the competitor's prices with the provider's price to determine whether the provider should lower its price.

A determination is made as to whether to change the provider's data values based upon the analysis of the competitors' data values (decision 530). If processing should not change the provider's data value, decision 530 branches to “No” branch 538 bypassing data value-changing steps. On the other hand, if processing should change provider data values, decision 530 branches to “Yes” branch 532 whereupon processing adjusts the provider data values located in data store 130 at step 535. Using the example described above, processing may have determined that the provider's price for the electronic device is higher than the other three competitors. In this example, processing may adjust the provider's price to be lower than the three competitors' prices. Data store 130 is the same as that shown in FIG. 1 and may be stored on a nonvolatile storage area, such as a computer hard drive.

At step 540, processing extracts competitor display attributes from temp store 372, and analyzes the competitor's display attributes. For example, a competitor may display his name and data value in a large, bold font. A determination is made as to whether to change the provider's display attributes based upon the analysis of the competitor display attributes (decision 550). If processing should not change provider display attributes, decision 550 branches to “No” branch 558 bypassing display attribute-changing steps. On the other hand, if processing should change the provider display attributes, decision 550 branches to “Yes” branch 552 whereupon processing adjusts the provider display attributes that are located in data store 130 at step 555 (i.e. increase font size).

At step 560, processing extracts competitor and provider page position from temp store 372, and analyzes the page positions. For example, three competitors may have their data displayed at the top of the page of data, and the provider may have its data displayed at the bottom of the page of data. In this example, a user is able to view the three competitors' data, but has to scroll down to the bottom of the page of data in order to see the provider's data. A determination is made as to whether the provider has an acceptable page position (i.e. top of page) (decision 570). If the provider has an acceptable page position, decision 570 branches to “Yes” branch 578 bypassing page position-negotiating steps. On the other hand, if the provider does not have an acceptable page position, decision 570 branches to “No” branch 572 whereupon processing informs the provider that it does not have acceptable page position, and that the provider should take action, such as negotiate with a portal to receive adequate page position (step 580). Processing returns at 590.

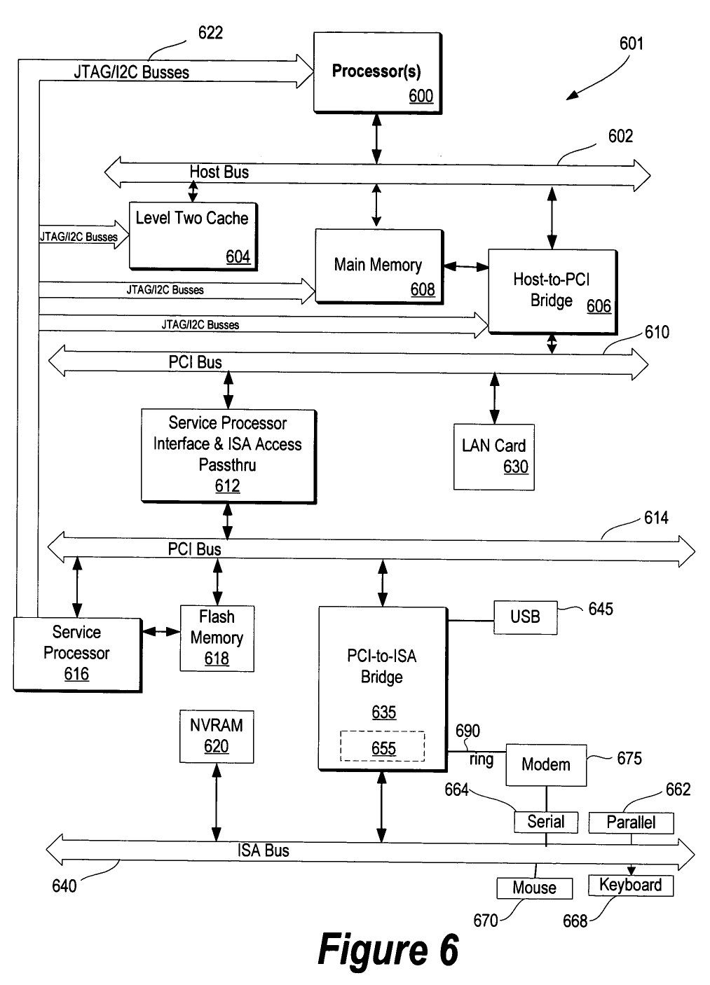

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
receiving a contribution request over a computer network, the contribution request corresponding to a client;
including provider data and an embedded program in a contribution response, wherein the embedded program is adapted to non-intrusively extract competitive data that is included in a page of data at the client; and
sending the contribution response over the computer network.

2. The method of claim 1 wherein the embedded program is further adapted to analyze the competitive data, the analysis further including:
comparing the competitive data with the provider data; and
changing the provider data in response to the comparing.

3. The method of claim 1 wherein the embedded program is further adapted to send the competitive data over the computer network.

4. The method of claim 3 further comprising:
receiving the competitive data;
comparing the competitive data with the provider data;
determining whether to change the provider data in response to the comparing;
changing the provider data in response to the determination, the changing resulting in changed provider data; and
sending the changed provider data to the client over the computer network.

5. The method of claim 1 wherein the contribution request is sent from a portal, and wherein the portal includes the provider data and the competitive data in the page of data.

6. The method of claim 1 wherein the competitive data is selected from the group consisting of a data value, a domain, a page position, and a display attribute.

7. The method of claim 1 wherein the embedded program is further adapted to extract a provider page position, the provider page position corresponding to the location of the provider data on the page of data.

8. An information handling system comprising:
one or more processors;
a memory accessible by the processors;
one or more nonvolatile storage devices accessible by the processors; and
a competitive analysis tool for analyzing competitive data, the competitive analysis tool comprising software code effective to:
receive a contribution request over a computer network, the contribution request corresponding to a client;
include provider data and an embedded program in a contribution response, wherein the embedded program is adapted to non-intrusively extract competitive data that is included in a page of data at the client; and
send the contribution response over the computer network.

9. The information handling system of claim 8 wherein the embedded program is further adapted to analyze the competitive data, wherein the software code is further effective to:
compare the competitive data with the provider data; and
change the provider data in response to the comparing.

10. The information handling system of claim 8 wherein the embedded program is further adapted to send the competitive data over the computer network.

11. The information handling system of claim 10 wherein the software code is further effective to:
receive the competitive data;
compare the competitive data with the provider data;
determine whether to change the provider data in response to the comparing;
change the provider data in response to the determination, the changing resulting in changed provider data; and
send the changed provider data to the client over the computer network.

12. The information handling system of claim 8 wherein the contribution request is sent from a portal, and wherein the portal includes the provider data and the competitive data in the page of data.

13. The information handling system of claim 8 wherein the competitive data is selected from the group consisting of a data value, a domain, a page position, and a display attribute.

14. The information handling system of claim 8 wherein the embedded program is further adapted to extract a provider page position, the provider page position corresponding to the location of the provider data on the page of data.

15. A program product comprising:
computer operable medium having computer program code, the computer program code being effective to:
receive a contribution request over a computer network, the contribution request corresponding to a client;
include provider data and an embedded program in a contribution response, wherein the embedded program is adapted to non-intrusively extract competitive data that is included in a page of data at the client; and
send the contribution response over the computer network.

16. The program product of claim 15 wherein the embedded program is further adapted to analyze the competitive data, wherein the computer program code is further effective to:
compare the competitive data with the provider data; and
change the provider data in response to the comparing.

17. The program product of claim 15 wherein the embedded program is further adapted to send the competitive data over the computer network.

18. The program product of claim 10 wherein the computer program code is further effective to:
receive the competitive data;
compare the competitive data with the provider data;
determine whether to change the provider data in response to the comparing;
change the provider data in response to the determination, the changing resulting in changed provider data; and
send the changed provider data to the client over the computer network.

19. The program product of claim 15 wherein the contribution request is sent from a portal, and wherein the portal includes the provider data and the competitive data in the page of data.

20. The program product of claim 15 wherein the competitive data is selected from the group consisting of a data value, a domain, a page position, and a display attribute.

21. The program product of claim 15 wherein the embedded program is further adapted to extract a provider page position, the provider page position corresponding to the location of the provider data on the page of data.

22. A method comprising:
receiving a contribution request over a computer network, the contribution request corresponding to a client;
including provider data and an embedded program in a contribution response, wherein the embedded program is adapted to non-intrusively extract competitive data that is included in a page of data at the client, and wherein the embedded program is further adapted to analyze the competitive data, the analysis further including:
comparing the competitive data with the provider data; and
changing the provider data in response to the comparing; and
sending the contribution response over the computer network.

23. An information handling system comprising:
one or more processors;
a memory accessible by the processors;
one or more nonvolatile storage devices accessible by the processors; and
a competitive analysis tool for analyzing competitive data, the competitive analysis tool comprising software code effective to:
receive a contribution request over a computer network, the contribution request corresponding to a client;
include provider data and an embedded program in a contribution response, wherein the embedded program is adapted to non-intrusively extract competitive data that is included in a page of data at the client, compare the competitive data with the provider data, and change the provider data in response to the comparing; and
send the contribution response over the computer network.

24. A program product comprising:
computer operable medium having computer program code, the computer program code being effective to:
receive a contribution request over a computer network, the contribution request corresponding to a client;
include provider data and an embedded program in a contribution response, wherein the embedded program is adapted to non-intrusively extract competitive data that is included in a page of data at the client compare the competitive data with the provider data, change the provider data in response to the comparing; and
send the contribution response over the computer network.

25. A method comprising:
receiving a contribution request over a computer network, the contribution request corresponding to a client;
including provider data and an embedded program in a contribution response, wherein the embedded program is adapted to non-intrusively extract competitive data that is included in a page of data at the client;
sending the contribution response over the computer network;
receiving the competitive data from the embedded program;
comparing the competitive data with the provider data;
determining whether to change the provider data in response to the comparing;
changing the provider data in response to the determination, the changing resulting in changed provider data; and
sending the changed provider data to the client over the computer network.

26. An information handling system comprising:
one or more processors;
a memory accessible by the processors;
one or more nonvolatile storage devices accessible by the processors; and
a competitive analysis tool for analyzing competitive data, the competitive analysis tool comprising software code effective to:
receive a contribution request over a computer network, the contribution request corresponding to a client;
include provider data and an embedded program in a contribution response, wherein the embedded program is adapted to non-intrusively extract competitive data that is included in a page of data at the client;
send the contribution response over the computer network;
receive the competitive data from the embedded program;
compare the competitive data with the provider data;
determine whether to change the provider data in response to the comparing;
change the provider data in response to the determination, the changing resulting in changed provider data; and
send the changed provider data to the client over the computer network.

27. A program product comprising:
computer operable medium having computer program code, the computer program code being effective to:
receive a contribution request over a computer network, the contribution request corresponding to a client;
include provider data and an embedded program in a contribution response, wherein the embedded program is adapted to non-intrusively extract competitive data that is included in a page of data at the client;
send the contribution response over the computer network;
receive the competitive data from the embedded program;
compare the competitive data with the provider data;
determine whether to change the provider data in response to the comparing;
change the provider data in response to the determination, the changing resulting in changed provider data; and
send the changed provider data to the client over the computer network.
